(19) United States
(12) Patent Application Publication
(10) Pub. No.: US 2025/0187994 A1
(43) Pub. Date: Jun. 12, 2025

(54) COMPOSITION COMPRISING PARTICLES OF SILICATE AND A GUM

(71) Applicant: SPECIALTY OPERATIONS FRANCE, Lyon (FR)

(72) Inventors: Ana Paula Bodemeier, Campinas (BR); Subramanian Kesavan, East Windsor, NJ (US)

(73) Assignee: SPECIALTY OPERATIONS FRANCE, Lyon (FR)

(21) Appl. No.: 18/845,391

(22) PCT Filed: Mar. 2, 2023
(86) PCT No.: PCT/EP2023/055385

§ 371 Date: Sep. 9, 2024

(30) Foreign Application Priority Data
Mar. 9, 2022 (WO) PCT/EP2022/056075

(51) Int. Cl. C05D 9/02; C05G 5/27

(52) U.S. Cl. CPC C05D 9/02; C05G 5/27

(57) ABSTRACT

The present invention is related to a composition comprising: —particles of at least one silicate, and —diutan gum. The present invention also discloses a method for treating a seed and/or a plant wherein such a composition is applied onto or next to at least one seed or at least one part of a plant.

The present invention concerns a composition comprising particles of at least one silicate and diutan gum.

Agrochemical compositions comprising mineral components such as silicates are already known in the prior art.

For example, patent application CN 102726613 A discloses a nutrient solution for plants under the form of an aqueous composition containing chitin as well as different mineral ingredients including tourmaline powder and magnetite powder.

Such a composition is used as seed dressing agent with the aim of increasing the germination rate and is further described as a fertilizer and growth promoter.

Plant, soil and seed treatments are used on almost every commercial crop on the market today.

Suspension compositions are encountered in a variety of industries, including agrochemicals. The development of concentrated suspensions containing silicate particles is known by those skilled in the art.

The use of silicate compositions containing high content of particles and further comprising dispersants and xanthan gum in the agrochemical field is disclosed in WO2020/254854.

The main drawback concerning development of suspension compositions is to maintain its stability, which means, the suspension must be capable of suspending the dispersed phase throughout the product's shelf life. This is even more challenging in concentrated suspensions.

In such compositions, the addition of dispersants is performed in a way to increase the charge on the surface of the particles or to create steric hindrance and/or electric charges improving the separation of the particles and avoiding their aggregation and/or sedimentation.

There is a continuous need for providing improved compositions for agriculture needs. Such compositions shall fulfill multiple different needs such as promote germination and plant growth, help increase agricultural yields, and should also have good intrinsic properties, in particular good physicochemical properties such as a good stability on storage.

The inventors of the present application have now discovered that suspension compositions comprising diutan gum and high content of silicate particles exhibits improved stability, without solid sedimentation, even when no dispersant is added, which make it particularly efficient when used in agrochemistry.

Therefore, the present invention concerns a composition comprising:
particles of at least one silicate, and
diutan gum
wherein the particles of at least one silicate represent from 10 to 80% by weight with regard to the total weight of the composition.

The composition preferably further comprises an aqueous liquid carrier.

Advantageously, the presence of diutan gum enables to increase the stability of such a composition.

The present invention also concerns a method for treating a seed and/or a plant wherein such a composition is applied onto or next to at least one seed or at least one part of a plant.

Indeed, it was found that the composition of the present invention provides an agrochemical treatment of seeds and/or plants, which leads to an improved germination rate of the seeds and consequently the enhancement of plants growth, and in a general manner to improved yields.

Then, another object of the present invention is the use of such a composition to improve the germination of seeds.

Other subjects, characteristics, aspects and advantages of the invention will emerge even more clearly on reading the description and the examples that follow.

In the present description, and unless otherwise indicated:
the expression “at least one” is equivalent to the expression “one or more” and can be replaced therewith;
the expression “between” is equivalent to the expression “ranging from” and can be replaced therewith and implies that the limits of the range are included.
the expression “weight percent,” “wt %,” “percent by weight,” “% by weight,” and variations thereof refer to the concentration of a substance as the weight of that substance divided by the total weight of the composition and multiplied by 100.
the expression “comprising one” or “comprising an” should be understood as being synonymous with the term “comprising at least one”, unless otherwise specified, “between” and “from . . . to . . . ” should be understood as being inclusive of the limits.

The composition of the present invention contains solid particles of one or more silicate(s).

The silicate is preferably selected from the group consisting of micas, aluminosilicates, tourmalines, serpentines and mixtures thereof.

The aluminosilicates can belong to clays or not.

Among the aluminosilicates, mention can be made of some groups such as feldspars, zeolites and kaolinites, and of specific aluminosilicates such as for example petalite, prehnite, delhayelite, bannisterite, allophane, crysocolla, minehillite, wickendurgite, franklinphilite.

Among the aluminosilicates from clay materials, besides the kaolinites, mention can be made of minerals from chlorite group, illite, glauconite, montmorillonite, palygorskite, pyrophyllite, sauconite and vermiculite.

According to a most preferred embodiment, the silicate is selected from the group consisting of tourmalines.

Tourmalines are crystalline boron silicate minerals compounded with elements such as aluminum, iron, magnesium, sodium, lithium, or potassium.

We can cite Schorl, Dravite and Elbaite species.

The D90 size of the particles of silicate preferably ranges from 0.1 to 30 μm, preferably from 0.5 to 20 μm, more preferably from 1 to 15 μm, even more preferably from 2 to 10 μm and most preferably from 5 to 7 μm.

In a manner known per se in the field of particle size analysis, D90 designates the point in the volume size distribution of a population of particles, up to and including which, 90% of the total population is contained. In other words, D90 is defined by the value in the particle size distribution of a sample where 90% of the particles present in the sample are equal or below that value. For example, a sample of particles having a D90 of 1 μm means that 90% by volume of the sample has a size of 1 μm or smaller.

The size distribution of a sample of particles can be measured using the laser diffraction particle size analysis method (using, for example, Malvern or Cilas particle size analyzers). One advantageous way to carry out the process consists in suspending the particles in water and in determining their particle size by laser diffraction using the method described in standard ISO 13320:2009.

The particles of at least one silicate represent from 10 to 80% by weight with regard to the total weight of the composition, preferably from 15 to 70% by weight, more preferably from 20 to 60% by weight, with regard to the total weight of the composition. The above quantities are defined for the composition before any optional dilution that could be performed before application onto plants and/or seeds and/or soil.

The composition of the invention further contains diutan gum.

Diutan gum is a natural high-molecular-weight polysaccharide produced by carefully controlled aerobic fermentation, specifically via fermentation of strain Sphingomonas sp. ATCC 53159.

The repeating unit of diutan gum is composed of a six-sugar unit. A tetrasaccharide backbone structure that contains L-mannose, L-rhamnose, D-glucose and D-glucuronic acid while the side chain contains two L-rhamnose. Progress has been made in elucidating the genetics and biochemistry underlying biosynthesis of diutan gum. A cluster of genes involved in biosynthesis of diutan has been identified that includes genes for glycosyl transferases, genes encoding enzymes for synthesis of a precursor molecule dTDP rhamnose, and genes for secretion of the polysaccharide.

The above diutan gum is well known in the art and is commercially available and is currently used mainly in cement and concrete.

In a preferred embodiment, the amount of diutan gum ranges from 0.05 to 5%, preferably from 0.1 to 2% by weight, based on the total weight of the composition.

In some aspects, the molecular weight of diutan gum is about 2.88 to 5.18 million Daltons.

According to one embodiment, the weight ratio between the total amount by weight of particles of silicate in the composition on one hand and the total amount by weight of diutan gum in the composition on the other hand is from 20:0.5 to 700:2, preferably from 16:0.5 to 600:1, based on the total weight of the composition.

Advantageously, the composition of the present invention further comprises one or more antifreezing agent(s).

These antifreezing agent(s) are preferably a glycol selected from propylene glycol and glycerol.

Indeed, it was observed, totally unexpected, that the use of a combination of diutan gum and propylene glycol and/or glycerol was able to produce a synergistic effect leading to improved stability of the composition, in a way that no sedimentation of particles/solid was obtained.

The amount of one or more antifreezing agent(s) ranges from 1 to 10%, preferably from 2 to 8% by weight, more preferably from 3 to 6% by weight, based on the total weight of the composition.

According to a preferred embodiment, the weight ratio between the total amount by weight of glycol on one hand and the total amount by weight of diutan gum in the composition on the other hand is from 0:0.1 to 100:1, preferably from 2:1 to 60:1, based on the total weight of the composition.

When used, the carrier of the composition of the invention is liquid at ambient temperature (25° C.) and atmospheric pressure (1,013.105 Pa).

The composition of the invention may contain an aqueous liquid carrier that is to say the carrier contains water. The carrier can be made of water, or of water mixed with one or more organic fluid(s), which can be water-miscible or not.

When the carrier contains water and one or more water-immiscible organic fluid(s), said carrier may be in the form of an emulsion.

The organic fluids can be for example chosen from natural or synthetic oils, in particular mineral oils, vegetable oils, fatty or non fatty alcohols, fatty acids, esters containing at least one fatty acid and/or at least one fatty alcohol.

The fatty alcohols and fatty acids mentioned above are those which contain from 8 to 32, preferably from 10 to 26 and more preferentially from 12 to 22 carbon atoms.

The organic fluids when used are preferably water-miscible in any proportions. They can in particular be chosen from mono-alcohols containing from 2 to 5 carbon atoms, such as ethanol and isopropanol and from polyols such as, in particular, glycol, glycerol, saccharides such as sorbitol.

It is of course possible to use mixtures of organic fluids and in particular any mixtures of any of the fluids described above.

According to one particularly preferred embodiment, the carrier of the composition used in the present invention is water.

The composition advantageously contains at least 20% by weight of water, preferably at least 30% by weight of water, relative to the total weight of said composition.

When one or more organic fluids are present, the composition preferably contains from 0.005% to 2% by weight of organic fluid(s), more preferentially from 0.01% to 1% by weight of organic fluid(s), relative to the total weight of said composition.

According to the invention, the composition is advantageously under the form of a suspension of said solid particles within the liquid carrier.

According to a preferred embodiment, the composition containing said particles of silicate further contains one or more biocide.

A biocide is a chemical substance capable of killing different forms of living organisms used in fields such as medicine, forestry, and mosquito control.

Usually biocides are divided into two sub-groups:
pesticides, which includes herbicides, insecticides and insect repellants, fungicides, rodenticides, algicides, moluscicides and miticides,
antimicrobials, which includes germicides, antibiotics, antibacterials, antivirals, antifungals, antiprotozoals and antiparasites.

Useful biocides may be chosen, in a non-limitative manner, among the following compounds: triazine herbicides, sulfonylurea herbicides, uracils, urea herbicides, acetanilide herbicides, organophosphonate herbicides, glyphosate salts, glyphosate esters, nitrilo oxime fungicides, imidazole fungicides such as for example carbendazim, triazole fungicides, sulfenamide fungicides, dithiocarbamate fungicides such as for example thiram, chlorinated aromatic, dichloro aniline fungicides, strobilurin fungicides such as for example pyraclostrobin, carbamate insecticides, organo thiophosphate insecticides; perchlorinated organic insecticides, phenylpyrazole insecticides such as fipronil, methoxychlor, miticides, propynyl sulfite, triazapentadiene miticides, chlorinated aromatic miticides, tetradifan, dinitrophenol miticides, binapacryl, thiophanatemethyl and mixtures thereof.

Preferably, the biocide used in the present invention is a pesticide, and more preferably a pesticide selected from herbicides, insecticides and fungicides. According to a particularly preferred embodiment, the composition contains at least one fungicide.

The composition according to the present invention may further contain one or more fertilizers, preferably chosen from water-soluble fertilizers such as for example foliar fertilizers (fertilizers which are taken up by the leaves of the plants), such as urea or foliar macro- or microelement fertilizer, including chelates. Fertilizers are generally used for foliar and soil applications.

The composition according to the present invention may further contain one or more nutrients, such as algae extract, aminoacids, cobalt, molybdenum, micronutrients. Nutrients are generally used for seed coating applications.

The composition may further contain additional ingredients, which can be chosen from all additives and adjuvants useful in agrochemical compositions such as for example anti-foaming agents, colorants such as pigments, etc.,

According to a preferred embodiment, the composition of the present invention does not contain any dispersant.

All the amounts above are defined considering a “concentrated” composition, that is to say that the above composition according to the invention can be diluted or not before an application onto the crop. It is preferred to dilute said composition for foliar spray onto the leaves of the plant. For use in the soil or onto the seeds, a dilution is generally not performed, but the composition can be mixed together with other compositions (e.g. fungicide compositions, nutrient compositions, etc, which generally contain a liquid carrier).

Notably for foliar application, it is thus also an object of the present invention a ready-to-use composition of the invention and in this case all the above amounts (percentage by weight based on the total weight of the concentrated composition) would be divided by from 10 to 500, preferably by 50 to 200 and notably by around 100. In this embodiment, the concentrated composition would be diluted just before application and the additional ingredients like fungicides, fertilizers and/or nutrients are generally added at this dilution moment. The dilution would thus be from 10 to 500, preferably by 50 to 200 and notably by around 100.

The composition according to the invention can be prepared by simple mixing of the ingredients, i.e
particles of at least one silicate;
diutan gum, and;
an aqueous carrier.

To prepare the “concentrated” composition, that is to say a composition with the above described ranges of amounts of ingredients, without further dilution, the ingredients can be mixed in any order.

In a particularly preferred embodiment, into the particles of the at least one silicate, preferably in the form of an aqueous suspension, the diutan gum is added.

The present invention also concerns a method for treating a seed and/or a plant wherein a composition as described above is applied onto or next to at least one seed or at least one part of a plant.

The composition described above can be either applied as such directly onto or next to the seed or to the plant, or it can be diluted just before application for example with a liquid diluent comprising water or a mixture of water and organic solvent, or it can be mixed just before application with another agrochemical composition.

The method of the present invention can be implemented on any type of seed or plant. The seeds or plants are preferably chosen among agricultural and horticultural plants, shrubs, trees and grasses.

In one embodiment, the seed is of the crop or plant species including but not limited to corn (Zea mays), Brassica sp. (e.g., B. napus, B. rapa, B. juncea), alfalfa (Medicago sativa), rice (Oryza sativa), rye (Secale cereale), Sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), Citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), Macadamia (Macadamia integrifolia), almond (Prunus amygdalus), sugar beets (Beta vulgaris), sugarcane (Saccharum spp.), canola, oats, barley, vegetables, ornamentals, woody plants such as conifers and deciduous trees, squash, pumpkin, hemp, zucchini, apple, pear, quince, melon, plum, cherry, peach, nectarine, apricot, strawberry, grape, raspberry, blackberry, Sorghum, sugarcane, rapeseed, clover, carrot, and Arabidopsis thaliana.

Further examples of seeds or plants is of any vegetables species including but not limited to tomatoes (Lycopersicon esculentum), lettuce (e.g., Lactuca sativa), green beans (Phaseolus vulgaris), lima beans (Phaseolus limensis), peas (Lathyrus spp.), cauliflower, broccoli, turnip, radish, spinach, cabbage, asparagus, onion, garlic, pepper, celery, and members of the genus Cucumis such as cucumber (C. sativus), cantaloupe (C. cantalupensis), and musk melon (C. melo).

Mention can further be made of seeds or plants of ornamentals species including but not limited to hydrangea (Macrophylla hydrangea), Hibiscus (Hibiscus rosasanensis), petunias (Petunia hybrida), roses (Rosa spp.), azalea (Rhododendron spp.), tulips (Tulipa spp.), daffodils (Narcissus spp.), carnation (Dianthus caryophyllus), poinsettia (Euphorbia pulcherrima), and Chrysanthemum; and of conifer species including but not limited to conifers pines such as loblolly pine (Pinus taeda), slash pine (Pinus elliotii), ponderosa pine (Pinus ponderosa), lodgepole pine (Pinus contorta), and Monterey pine (Pinus radiata), Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis).

In one embodiment, the seed or plant is chosen from leguminous plant species including but not limited beans and peas. Beans include guar, locust bean, fenugreek, soybean, garden beans, cowpea, mungbean, lima bean, fava bean, lentils, chickpea, green pea, moth bean, broad bean, kidney bean, lentil, dry bean, etc. Legumes include, but are not limited to, Arachis, e.g., peanuts, Vicia, e.g., crown vetch, hairy vetch, adzuki bean, mung bean, and chickpea, Lupinus, e.g., lupine, trifolium, Phaseolus, e.g., common bean and lima bean, Pisum, e.g., field bean, Melilotus, e.g., clover, Medicago, e.g., alfalfa, Lotus, e.g., trefoil, lens, e.g., lentil, and false indigo. Typical forage and turf grass for use in the methods described herein include but are not limited to alfalfa, orchard grass, tall fescue, perennial ryegrass, creeping bent grass, lucerne, birdsfoot trefoil, clover, Stylosanthes species, Lotononis bainessii, sainfoin and redtop. Other grass species include barley, wheat, oat, rye, orchard grass, guinea grass, Sorghum or turf grass plant.

According to a preferred embodiment, the seed or plant is selected from the group consisting of soy, cane, cotton, wheat, beans, rice, and preferably the plant is soy.

It is understood that the term “seed” or “seedling” is not limited to a specific or particular type of species or seed. The term “seed” or “seedling” can refer to seed from a single plant species, a mixture of seed from multiple plant species, or a seed blend from various strains within a plant species. In one embodiment, crop seeds include but are not limited to rice, corn, wheat, barley, oats, soybean, cotton, sunflower, alfalfa, Sorghum, rapeseed, sugarbeet, tomato, bean, carrot, tobacco or flower seeds.

In a general manner, the composition of the invention can be easily applied onto plants or parts thereof using any conventional and commercially available application equipment.

Typically, the composition of the present invention can be applied onto or next to seeds.

In one embodiment, the method of the present invention comprises a step in which the seed is coated with the composition as described above. Then the coated seed may be applied onto or in the soil, notably, in order to set in contact the coated seed with the ground.

Suitable coating techniques may be utilized to coat the seed or agglomeration of the seeds with the composition according to the present invention. Equipment that may be utilized for coating can include but are not limited to drum coaters, rotary coaters, tumbling drums, fluidized beds and spouted beds. It is appreciated that any suitable equipment or technique known by a person skilled in the art may be employed. The seed may be coated via a batch or continuous coating process. The seed may be coated with the composition according to the present invention.

One advantage of the present invention is that the suspension containing high content of particles according to the present invention has excellent stability and, thus, delivers the desired dosage and can be conveniently used for treating the seeds or the soil.

The seeds may be separated prior to the coating step. In one embodiment, mechanical means, such as a sieve, may be employed for separating the seeds. The separated seeds can then be introduced into a coating machine having a seed reservoir. In one embodiment, the seeds are combined with the composition described herein, optionally with a binder and/or adhesive, in a mixing bowl.

In some aspects, one or more layers of coating which comprises the composition according to the present invention may be added onto the seeds or the agglomeration thereof. Outer layers can be introduced sequentially by coating the seeds or the agglomeration thereof in a rotating drum.

Agglomerators or agglomerator devices may also be utilized. Coating may be performed within a rotary coater by placing the seeds within a rotating chamber, which pushes the seeds against the inside wall of the chamber. Centrifugal forces and mixing bars placed inside the coater allow the seeds to rotate and mix with a coating layer comprising the composition according to the present invention. Binder or other coating materials can be pumped into the proximate center of the coater onto an atomizer disk that rotates along with the coating chamber. Upon hitting the atomizer disk, liquid adhesive is then directed outward in small drops onto the seeds.

Seed coating techniques also include, for example, placing the seeds in a rotating pan or drum. The seeds are then mist with water or other liquid, and then gradually a fine inert powder, e.g., diatomaceous earth, is added to the coating pan. Each misted seed becomes the center of a mass of powder, layers, or coatings that gradually increases in size. The mass is then rounded and smoothed by the tumbling action in the pan, similar to pebbles on the beach. The coating layers are compacted by compression from the weight of material in the pan. Binders often are incorporated near the end of the coating process to harden the outer layer of the mass. Binders can also reduce the amount of dust produced by the finished product in handling, shipping and sowing. Screening techniques, such as frequent hand screening, are often times utilized to eliminate blanks or doubles, and to ensure uniform size. For example, tolerance for seed coating compositions described herein can be +/− 1/64 inch (0.4 mm), which is the US seed trade standard for sizing, established long before coatings were introduced. For example, coated lettuce seed is sown most frequently with a belt planter through an 8/64 inch (3.2 mm) diameter round holes in the belt. This hole size requires that the lettuce seeds coated with the composition according to the present invention can be sized over a 7.5/64 inch (3.0 mm) screen and through an 8.5/64 inch (3.4 mm) screen.

In one embodiment of the present invention, the seed may be contacted with the composition by using an “in situ coating” process, notably by implanting in a hole or “in-furrow” in the soil a seed of a plant, and then applying the composition according to the present invention to surround or partially surround, or to be adjacent to the seed, so that the seed come into contact with the composition, notably with the silicate particles. According to the invention, the hole or furrow may notably be a hole, a cavity or a hollowed area. The seed may be one that has not be treated by any agent, or a seed that has been treated with an agrochemical (such as fungicide and insecticide) and that has not been treated with the composition of the present invention. Preferably, the composition is in liquid form, such as in the form of aqueous suspension.

In still another embodiment, the composition according to the present invention is administered to a soil in which a plant is cultivated. Then the seeds of the plant can be applied to the soil so that the seeds will come into contact with the composition, particularly with the silicate particles. Notably, the composition in liquid form, such as in the form of aqueous suspension, may be used.

Preferably, the application of the seed and the application of the composition according to the present invention are performed mechanically. It is appreciated that either or both of the referenced applications can be performed manually as well.

In a particular preferred embodiment, the composition is applied onto or next to a seed, preferably by coating the seed with the composition or by directly applying the composition in-furrow of seed planting immediately before, during or immediately after planting a seed in the furrow.

In one embodiment of the present invention, the silicate is used in an amount ranging from 240 to 1360 g/quintal seed.

The composition of the invention can be applied on the plant at any stage of its development. It can be applied on the whole plant or on parts thereof.

According to a preferred embodiment, the composition is applied onto the foliar system of the plant. Such application is preferably carried out by spraying a composition as disclosed above onto the leaves of the plant. For example, the composition can be sprayed onto a field using appropriate means well known in agriculture.

In a general manner, the composition of the invention can be easily applied onto or next to plants or parts thereof using any conventional and commercially available application equipment.

The invention also concerns the use of a composition as disclosed above for improving the germination of seeds.

In one preferred embodiment, the use of the composition as disclosed above leads to an improvement in the germination of seeds treated with such a composition and consequently, not only enhancing the yield of the crop, but also enhancing the growth of the obtained plant, notably permitting to develop and to increase its biomass.

The above description of the method of the invention also applies to the use according to the invention.

The examples of implementation of the invention below are given purely by way of illustration and shall not be interpreted at limiting the scope thereof.

### EXAMPLES

A series of compositions (samples E1 to E5), including comparative compositions (sample E1, E2 and E5) were prepared and evaluated according to stability and germination rate. Comparative composition (sample E1, E2 and E5) were prepared using dispersants and a gum different from diutan gum, for example xanthan gum. Table 1 summarizes the samples.

### Materials:

The minerals used in the below described experiments is a powder of black tourmaline from Micro Service-Tecnologica em Micronização, Produtos e Processos Industriais with D90=6 μm (referenced as G2g below).

Other compound used to prepare samples:
Lamegal HS/B—dispersant containing sodium polycarboxylate in aqueous solution Mw=2000 g/mol at a concentration of 40 to 42% by weight—from Lamberti
Geropon T 36—dispersant containing sodium polycarboxylate in aqueous solution at a concentration of 90% by weight—from Solvay
Rhodopol 23—xanthan gum at a concentration of 1% or 2% by weight in aqueous solution—from Solvay
Proxel GXL—an aqueous solution of 1,2-benzisothiazolin-3-one—from Lonza
Kelco Vis DG—diutan gum at a concentration of 1% by weight in aqueous solution—from CP Kelco
Rhodoline 111—an aqueous solution containing polycarboxylic acid sodium salt at a concentration of 20-25% by weight—from Solvay.

### Preparation of Compositions

Six samples were prepared using compositions in aqueous concentrated suspension form including comparative compositions containing dispersant and xanthan gum. Firstly a premix was prepared adding Proxel GLX and G2g (tourmaline D90=6 μm) and optionally Lamegal HS/B and Geropon T 36 using IKA RW20 mechanical controlled stirrer under 1000 rpm.

Then, a solution containing 1% of diutan gum or 1 or 2% of xanthan gum, optionally including propylene glycol/polycarbolylate acid sodium salt were added on the first premix under 600 rpm until homogenous dispersion.

Different samples are demonstrated in Table 1 below:

TABLE 1
Suspension compositions

| | Sample E1 | Sample E2 | Sample E3 | Sample E4 | Sample E5 | Sample E6 |
|---|---|---|---|---|---|---|
| Components | (Comparative) | (Comparative) | (invention) | (invention) | (Comparative) | (Comparative) |
| G2g | 60% | 60% | 60% | 60% | 60% | 60% |
| (tourmaline | | | | | | |
| D90 = 6 μm) | | | | | | |
| Lamegal | 0.1% | | | | | |
| Geropon | 0.65% | | | | | |
| T36 | | | | | | |
| Proxel GLX | 0.5% | 0.5% | 0.5% | 0.5% | 0.5% | 0.5% |
| Propylene | | | | 6% | 6% | |
| Glycol | | | | | | |
| Rhodoline | | | | | | 6% |
| 111 | | | | | | |
| Rhodopol 23 | 0.1% | 0.1% | | | 0.1% | |
| Kelco Vis | | | 0.1% | 0.1% | | 0.1% |
| DG | | | | | | |
| Demineralized | 38.65% | 39.4% | 39.4% | 33.4% | 33.4% | 33.4% |
| water | | | | | | |
| Total | 100% | 100% | 100% | 100% | 100% | 100% |
| amounts | | | | | | |
| (in % by | | | | | | |
| weight) | | | | | | |

### Example 1: Stability Evaluation on Storage-Accelerated Procedure

5 The stability evaluation of the samples was determined using methodology based on CIPAC MT 46.3 for accelerated storage procedure. The samples were stored for 2 weeks under different temperatures: −5° C., 0° C., 25° C., 45° C. and 54° C. After the period, samples were evaluated to determine phase separation and results were demonstrated on Table 2 below:

TABLE 2
Accelerated stability of compositions:

| | Phase | Phase | Phase | Phase | Phase |
|---|---|---|---|---|---|
| | Sep- | Sep- | Sep- | Sep- | Sep- |
| | aration | aration | aration | aration | aration |
| | (after 2 | (after 2 | (after 2 | (after 2 | (after 2 |
| | weeks | weeks | weeks | weeks | weeks |
| Sample | −5° C.) | 0° C.) | 25° C.) | 45° C.) | 54° C.) |
| E1 | 0 | 0 | 0 | 10% | 13% |
| (Comparative) | | | | | |
| E2 | 0 | 0 | 0 | 9% | 10% |
| (Comparative) | | | | | |
| E3 (Invention) | 0 | 0 | 0 | 0 | 2% |
| E4 (Invention) | 0 | 0 | 0 | 0 | 0 |
| E5 | 0 | 0 | 0 | 8% | 9% |
| (Comparative) | | | | | |
| E6 | 0 | 0 | 10% | 10% | 10% |
| (Comparative) | | | | | |

It can be seen that samples E3, corresponding to the composition containing diutan gum, and E4 corresponding to the composition containing diutan gum and propylene glycol showed better stability under storage regarding phase separation detection.

Comparative samples E2 and E5 corresponding to similar compositions but containing xanthan gum showed poor stability, demonstrating visible phase separation. Phase separation was even worse considering Comparative sample E1, corresponding to composition containing xanthan gum and dispersants.

Comparative sample E6 corresponding to compositions similar to E3 and E4 but containing polycarboxylate acid sodium salt replacing the glycol showed very poor stability, demonstrating visible phase separation even when storage at 25° C.

### Example 2: Physical Stability Characterization

The physical stability characterization of the comparative composition E1 and the Invention compositions E3 and E4 was assessed as follows.

The samples were stored for 14 days in an experimental area under 54° C. After this period, the suspensibility of each sample was determined.

The results obtained are detailed in Table 3 below:

TABLE 3

| Physical stability results | |
|---|---|
| Sample | Suspensibility (%) |
| E1 (Comparative) | 78 |
| E3 (Invention) | 88 |
| E4 (Invention) | 88 |

The term “suspensibility” designates the amount of particles that remains as a suspension after 30 min. The reference method used to determine the supensibility was Brazilian standard ABNT NBR 13313.

The suspensibility of the samples E3 and E4 demonstrated better results in comparison with Comparative sample E1.

### Example 3: Stability Evaluation on Long Storage

Inventive compositions containing a combination of diutan gum and different glycols were evaluated according to its stability under long storage. The samples were prepared considering the same protocol used to prepare sample E4 (Invention) and replacing propylene glycol for different glycols according to Table 4 below:

| Components | Sample | Sample | Sample | Sample |
|---|---|---|---|---|
| (% by weight) | E4A | E4B | E4C | E4D |
| G2 g (tourmaline | 60% | 60% | 60% | 60% |
| D90 = 6 μm) | | | | |
| Proxel GLX | 0.5% | 0.5% | 0.5% | 0.5% |
| Glycerol | 6% | | | |
| Monoethylene glycol | | 6% | | |
| Butyl glycol | | | 6% | |
| Hexylene glycol | | | | 6% |
| Kelco Vis DG | 0.1% | 0.1% | 0.1% | 0.1% |
| Demineralized water | 33.4% | 33.4% | 33.4% | 33.4% |
| Total amounts | 100% | 100% | 100% | 100% |
| (in % by weight) | | | | |

Compositions of samples E4, E4A, E4B, E4C and E4D were submitted to stability evaluation on long storage considering 8 weeks of storage under different temperatures: −5° C., 0° C., 25° C. and 45° C. Evaluation was performed to determine phase separation and results were demonstrated on Table 5 below:

TABLE 5
Long term stability of compositions:

| | Phase | Phase | Phase | Phase |
|---|---|---|---|---|
| | Separation | Separation | Separation | Separation |
| | (after 8 weeks | (after 8 weeks | (after 8 weeks | (after 8 weeks |
| Sample | −5°C) | 0° C.) | 25° C.) | 45° C.) |
| E4 | 0 | 0 | 0 | 0 |
| E4A | 0 | 0 | 0 | 0 |
| E4B | 0 | 0 | 0 | 5% |
| E4C | frozen | frozen | 2% | 5% |
| E4D | 0 | 0 | 2% | 5% |

The above results demonstrated that compositions according to the invention containing a combination of diutan gum and propylene glycol (E4) or glycerol (E4A) showed excellent stability under long storage compared to compositions containing different glycols (E4B, E4C and E4D).

### Example 4: Germination Trials

Germination trials were conducted in a greenhouse covered with transparent acrylic tiles.

Seeds (Soybean M5947 Ipro, Monsoy branch) were previously coated using compositions according to samples E1 (Comparative), E3 (Invention), E4 (Invention) and compared to Control seeds (seeds not submitted to coating treatment). The coating was carried out in an experimental area in the city of Londrina, Parana State in Brazil, using the following characteristics: average temperature of 20.5° C., 82% RH, cloudy sky, from 8:30 am to 10:10 am. Seeds were treated in plastic pots, using amounts of samples of 4 mL/kg seeds (w/w), water was added up to the slurry to complete the volume of 0.90 L/100 kg seeds. Seeds were shaken until complete coverage and homogenization.

In a second step, seeds were stored for 0 days (T1, T2, T3 and T4) or 30 days (T1′, T2′, T3′ and T4′) in a warehouse with temperature between 20-25° C. and 50-56% RH.

Then, seeds treated were submitted to germination trials for which they were planted using the protocol as follow: tests were carried out in plastic polypropylene trays with sand soil and watering conditions of 200 mL water each 2 days, with a temperature of between 22-34° C. and 40-65% RH according to the Brazilian normatives of the MAPA Seeds Manual (Brasil, 2009). The germination rate of the seeds and aerial parts of plants after germination were measured and summarized in Table 5 below.

TABLE 5
Germination rate and length of aerial parts of samples.

| | Germination | Germination | Length |
|---|---|---|---|
| | rate | rate (17 | Aerial Part |
| Treated samples | (5 days ) | days) | (17 days) |
| T1 - Control | 100% | 100% | 23.3 cm |
| T2 - E1 (comparative) | 147% | 113% | 25.2 cm |
| T3 - E3 (invention) | 134% | 108% | 25.9 cm |
| T4 - E4 (invention) | 142% | 110% | 23.9 cm |
| T1′ - Control | 100% | 100% | 16.9 cm |
| T2′ - E1 (comparative) | −151% | −131% | 16.4 cm |
| T3′ - E3 (invention) | 108% | 104% | 17.5 cm |
| T4′ - E4 (invention) | 110% | 105% | 19.6 cm |

Germination rate means the additional number of plants emerging out of soil in comparison with Controls (T1 or T1′) and transformed into a percentage value, considering the value of Control as 100%.

The length of aerial parts of the plants means medium length of all plants in the trays, after germination.

The above results showed that seeds treated with the compositions according to the invention demonstrated improved germination rates compared to the Control and Comparative samples both for seeds sown immediately after its coating (T3 and T4) and after storage for 30 days (T3′ and T4′).

The growth of plants derived from seeds treated with the compositions of the invention according to T3, T4, T3′ and T4′ was higher in comparison to the Controls (T1 or T1′) and Comparatives (T2 or T2′), considering both seeds sown immediately after coating treatment and stored for 30 days before sowing, demonstrating an improvement in the yield results of the crop.

Compositions according to the present invention demonstrated not only unexpected better stability but also an improvement in the germination of seeds and enhancement on the growth of the plants derived from seeds treated with such compositions immediately before sowing or even after storage, leading to better yields on crop and increased biomass of plants.

1. A composition comprising:
particles of at least one silicate, and
diutam gum,
wherein the particles of at least one silicate represent from 10 to 80% by weight with regard to the total weight of the composition.

2. The composition of claim 1, further comprising an aqueous liquid carrier.

3. The composition of claim 1, wherein the particles of at least one silicate is selected from the group consisting of micas, aluminosilicates, tourmalines, serpentines and mixtures thereof.

4. The composition of claim 1, wherein a D90 size of the particles of at least one silicate ranges from 0.1 to 30 μm.

5. The composition of claim 1, wherein the particles of at least one silicate represent from 15 to 70% by weight, with regard to the total weight of the composition.

6. The composition of claim 1, wherein the amount of diutan gum ranges from 0.05 to 5%, based on the total weight of the composition.

7. The composition of claim 1, wherein a weight ratio between a total amount by weight of particles of at least one silicate in the composition and a total amount by weight of diutan gum in the composition on is from 20:0.5 to 700:2, based on the total weight of the composition.

8. The composition of claim 1, further comprising one or more antifreezing agent.

9. The composition of claim 2, wherein the one or more antifreezing agent is a glycol selected from propylene glycol and glycerol.

10. The composition of claim 9, wherein the amount of said one or more antifreezing agent(s) ranges from 1 to 10%, based on the total weight of the composition.

11. The composition of claim 9 wherein the weight ratio between a total amount by weight of glycol and a total amount by weight of diutan gum in the composition is from 0:0.1 to 100:1, based on the total weight of the composition.

12. The composition of claim 2, wherein the aqueous liquid carrier is selected from water or water mixed with one or more organic fluid(s.

13. The composition of claim 12, containing at least 20% by weight of water, relative to the total weight of the composition.

14. The composition of claim 1, wherein the composition is in the form of a suspension.

15. A method for treating a seed and/or a plant wherein the composition as defined in claim 1 is applied onto or next to at least one seed or at least one part of a plant.

16. The method of claim 15, wherein the composition is applied directly onto or next to the seed or to the plant, or is diluted just before application with a liquid diluent comprising water or a mixture of water and organic solvent, or is mixed just before application with another agrochemical composition.

17. The method of claim 15, wherein the seed or plant is selected from the group consisting of soy, cane, cotton, wheat, beans, and rice.

18. The method of claim 15, wherein the composition is applied onto or next to the seed, by coating the seeds with the composition or by directly applying the composition in-furrow of seed planting immediately before, during or immediately after planting a seed in the furrow.

19. The method of claim 15, wherein the composition is applied onto the foliar system of the plant, by spraying said composition onto the leaves of the plant.

20. (canceled)

21. (canceled)
